(19) United States
(12) Patent Application Publication
(10) Pub. No.: US 2006/0260165 A1
(43) Pub. Date: Nov. 23, 2006

(54) Display case

(75) Inventor: Guy Gilbert Chenel, Boulogne Billancourt (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: PROCEDES CHENEL INTERNATIONAL, Vanves Cedex (FR)

(21) Appl. No.: 11/390,915

(22) Filed: Mar. 28, 2006

(30) Foreign Application Priority Data
Apr. 27, 2005 (FR) FR 05 51 089

(51) Int. Cl. G09F 17/00

(52) U.S. Cl. 40/603

(57) ABSTRACT

Display case with a geometric surface having a cylindrical structure with a convexly shaped section formed by a carcass supporting a bent panel provided with longitudinal slots and a facing sheet. The slot (5) of the carcass constitutes a fitting slot and the lateral edge of the sheet (7) is provided with a flexible strip (72) forming a fold line (73) at its junction with the body of the sheet and engages in the fitting slot (5) by a part of its length, whilst the remaining part (ΔL) is able to deform elastically and freely relative to the fitting slot (5) and the structure (1) in order to tense the sheet (1).

### FIELD OF THE INVENTION

The present invention relates to a display case which can be made with a geometric surface, having a cylindrical structure with a section of convex shape, comprising a carcass formed by a bent panel provided with longitudinal slots, and at least one facing sheet applied externally against the structure to envelop it, at least one lateral edge of which is folded and slipped through a longitudinal slot of the structure in order to retain the sheet.

In particular, the invention relates to a display case for decorative or information purposes, with a geometric surface of convex, polygonal or continuously curved section or a combination of these.

### PRIOR ART

Whereas they were once made in the form of metalwork or flat or moulded plastic panels, these cases are exclusively made from plastic materials these days, such as elastic and semi-rigid thin translucent sheets.

These cases with convex surfaces which can be made in different geometric shapes, are popular as decorations, for signs and for advertising material in the form of graphic supports. In effect, they are particularly elegant and attractive if they are luminescent and carry quality graphics.

The development of these cases is linked to the availability on the market of various materials in the form of thin, translucent sheets with differing degrees of elasticity, such as sheets of plastic, non-woven fabrics or papers of differing compositions or thicknesses. Some of these products additionally have a high resistance to fire, which is indispensable in certain applications.

These combinations of thin materials enable lightweight, flexible and resistant structures to be manufactured inexpensively. For example, it is well known that the inertia of thin sheets is easily increased if they are bent in a curve or folded (to a gutter or dihedral shape). However, if an elastic sheet is bent in a curve in this manner, it is necessary to apply a constant tension in order to preserve the assumed shape. In the case of these cases, the thin vertical cylinders of a shape conducive to withstanding compression stress and vertical load would be even more effective if they were made from flat elastic sheets, bent to form cylinders and retained by a constant tension.

These cylindrical cases constitute an elastic structure subjected to constant tension, which offers a major advantage. In the form in which they are used, the plastic sheets, which are rendered more rigid by bending, remain sufficiently elastic to absorb additional accidental deformations and then resume the given shape of equilibrium, for example if deformed due to impacts or having fallen. Being well protected, axial light sources are virtually unbreakable, as are the actual cases surrounding them and protecting them.

Accordingly, the carcasses of cases made from semi-elastic sheets are particularly durable and can therefore be re-used for a long time. The low-cost facing sheets, used as a base for interchangeable graphics carrying printed messages, can be replaced. They can be changed with every application.

Elastic luminous cases therefore have numerous advantages.

### TERMINOLOGY

The following terms will be used throughout the description: “Case”, the unit comprising the decorative or informative display element in its ready-to-use state. It is generally fitted with a light source, such as a fluorescent tube, positioned on its axis or close to its axis.

“Structure”, the unit comprising the internal resistant part made up of one or more bent panels maintained in a geometric shape by means of cross-pieces held in a tensed state by the action of the elasticity of the bent panel or sheets.

“Bent panel”, the part of the structure comprising at least one semi-flexible sheet bent in a curve and/or folded into a gutter shape to form all or part of the surface constituting the geometric, resistant surface of the case, to which the facing sheet is applied. The bent panel generally comprises a sheet of semi-flexible plastic material, which is significantly stronger than the facing sheet.

“Facing sheet” or “sheet” means the “skin” or “jacket” or “graphic base”. It is a fine, translucent and diffusing sheet used to face the case. It is significantly thinner than the sheet forming the bent panel of the carcass. More often than not, this facing sheet displays decorative or informative graphics.

The “width” of the component of a cylindrically shaped element extends in the direction of the directrix of the cylinder.

The “length” of the component of a same element extends in the direction of the generatrix or the “height” of structures such as those illustrated in FIG. 1.

The two “lateral strips” reinforce the sides of a sheet and enable sheets to be positioned.

More specifically, the cases in question are made up of two main elements:

A structure comprising one or more sheets of translucent, semi-rigid and elastic plastic material, about 0.5 to 1 mm thick. Once bent in order to increase its inertia, the straight edges of a bent panel constitute the edges which usually follow the generatrices of a cylinder (although this geometric shape may also be conical or pyramid-shaped). Together with a flap made by pre-folding a strip of the sheet, these edges form at least one inwardly directed groove. The bent panels are retained in the bent gutter shapes by clamping elements to prevent them from returning to their flat position of equilibrium due to elasticity.

The facing sheet, more often than not displaying decorative or informative graphics, comprises a sheet which diffuses a large amount of light but is much thinner than that of the carcass, being in the order of 0.2 mm thick. It has much less inertia than the sheets of the structure. It is usually prepared by a process of deformation under pressure and then one of its two longitudinal strips, which has been semi-stiffened beforehand, is returned to equilibrium.

However, this processing technique leads to the appearance of faults in the planimetry and irregularities that are intrinsic to the very nature of facing sheets. These very thin sheets of low inertia, even when bent, form waves once they are applied to curved structures. These defects in appearance are even more noticeable if the facing sheets are glossy, as is the case with the majority of thin, translucent photographic backings which diffuse a lot of light known under the name of backlights. The method currently used to strengthen the lateral strips of the skins is either to make them thicker by simply folding and gluing or providing panels with more edges, or by applying and gluing to them a semi-rigid, elastic thin strip of plastic, or by adopting a combination of both of these methods.

### OBJECTIVE OF THE INVENTION

The objective of the present invention is to improve a display case for decorative or informative purposes which can be made with a geometric surface and is used in particular in public places as an element for displaying publicity or announcements, and to remedy the irregular, wavy and relaxed appearance of facing sheets carrying the graphics in the case, which is very unsightly.

### ADVANTAGES OF THE INVENTION

To this end, the invention relates to a display case of the type defined above, characterised in that

the slot of the carcass constitutes a fitting slot,

at least one of the lateral edges of the sheet is provided with a flexible strip forming a fold line at its junction with the body of the sheet and is designed to be engaged in the fitting slot by a part of its width on the side of its free edge, whilst the remaining part of the width of the strip on the fold side is able to deform elastically and freely with respect to the fitting slot of the structure,

the width of the body of the sheet, as measured between the edge of the strip on the fold side and its other edge affixed to the structure, being shorter than the length of the cord at least partially supported on the structure and measured between the fixed edge of the sheet and the fold side edge of the strip when the strip is in a neutral position in which it is not elastically deformed, so that the strip engaged in a fitting slot transversely tenses at least part of the sheet against the structure due to the tension generated by the elastic deformation of the flexible strip.

The advantage of the case proposed by the invention is that it tenses the facing sheet or sheets perfectly on the carcass without any waviness, which would otherwise be detrimental to the aesthetic appearance and presentation of the information, to the point of making it difficult to read, especially if a more or less glaring light is directed at the structure. Furthermore, this tensioning of the facing sheet on the carcass, forming a unit comprising elements made from a semi-flexible material, creates a tension which stiffens the unit so that an impact locally deforming a part of the carcass incorporating the facing sheet will not cause any rupture or permanent deformation. The flexibility and elasticity of the structure incorporating the facing sheet enable the initial shape to be resumed.

This case may stand upright, be fixed to a wall, mounted at a height or mounted on hooks. It may be provided with one or more sources of illumination and, in the case of a case made by an assembly of several modules, the semi-flexible strips bordering the facing sheet enable the modules to be assembled and retained easily, superposed or suspended and stacked one above the other, due to the engagement of the strip in the fitting slot and the tension created by the deformation of the strip.

By virtue of another advantageous characteristic,

the other lateral edge of the sheet is also provided with a flexible strip, designed to be engaged in another fitting slot, where it is retained by a part of its width on the side of the free edge, whilst the remaining part of the width of the strip on the side of the fold is able to deform elastically with respect to the slot of the structure, and

the body of the sheet has a width as measured between its two folds which is shorter than the length of the cord at least partially supported on the structure and measured between the edge of each strip on the fold side when at least one of the strips is in a neutral position and not elastically deformed.

Although, in principle, it is possible to place the facing sheet under tension with the aid of only one flexible strip provided on an edge of the sheet, in order to simplify the manufacture and assembly so that there is only one way of fixing the facing sheet, it is useful to make a facing sheet with both edges incorporating a strip and, in particular, at least one of the edges is provided with a flexible strip of the type proposed within the meaning of the present invention, in other words one which creates a tension in the body of the facing sheet induced by deformation, once engaged in the fitting slot.

Accordingly, in this context, at least one of the flexible strips of the sheet has a width which is longer than the depth of the slot. The other strip may extend as far as the edge of the fitting slot and need not have any effect of elasticity in the sense of tension. However, given the fragility of the materials and in particular that of the facing sheet, it is preferable if the yield tension exerted on this sheet is distributed regularly and if the shape of the facing sheet is as symmetrical as possible, in other words the two edges are provided with a flexible strip which creates tension by deformation once it is engaged in the respective fitting slot.

By virtue of another advantageous characteristic, the case is made by assembling a bent panel with folded edges and tensed cross-pieces constituting a carcass, to which the folded edges are affixed in order to form the fitting slots.

In accordance with another advantageous characteristic, the case is formed by assembling two semi-flexible bent panels with folded edges constituting the structure, which are joined by these bent edges to form the fitting slots for the flexible strips of the facing sheets.

By virtue of another very advantageous characteristic, the joined folds of the bent panels or the joint between a fold and a carcass forming the fitting slots are assembled by intermittent assembly points in the form of rivets or press studs distributed in a defined manner along the height of each slot to form fitting zones around each rivet, and the flexible strips of the facing sheets have outer edges provided with notches with the same spacing as the rivets so that they can sit round the rivets and be engaged.

This mode of assembling the bent panels of the carcass represents a particularly simple solution in terms of assembling and dismantling the structure and also as a means of forming the fitting slots receiving the flexible strips of the facing sheet or sheets. Furthermore, due to the specific shape of the fitting system, the flexible strips enable a particularly interesting assembly of several superposed case modules, whether these cases are mounted, stand upright or are suspended.

### DRAWINGS

The present invention will be described in more detail below with reference to the appended drawings, of which:

FIG. 1 is a perspective view showing different shapes of the display case proposed by the invention,

FIG. 2 shows different sections of display cases along various directrices, in particular those indicated in FIG. 1,

FIGS. 3A-3D are schematic illustrations showing the main characteristics of the present invention,

FIG. 3A shows a schematic section along partial sections in the plane of the directrix of a case without its facing sheet,

FIG. 3B illustrates a section of a facing sheet for the carcass illustrated in FIG. 3A,

FIG. 3C illustrates how the length of the facing sheet proposed by the invention is defined,

FIG. 3D illustrates a facing sheet fitted on a carcass of a display case proposed by the invention,

FIG. 4 shows a first embodiment, illustrating how a display case is made, as viewed in section along one directrix,

FIGS. 5A, 5B respectively illustrate a partial section and a simplified view of a variant of the display case illustrated in FIG. 4 and the fitting of a facing sheet,

FIG. 6 illustrates a simplified section of another embodiment of a display case.

### DESCRIPTION OF EMBODIMENTS OF THE INVENTION

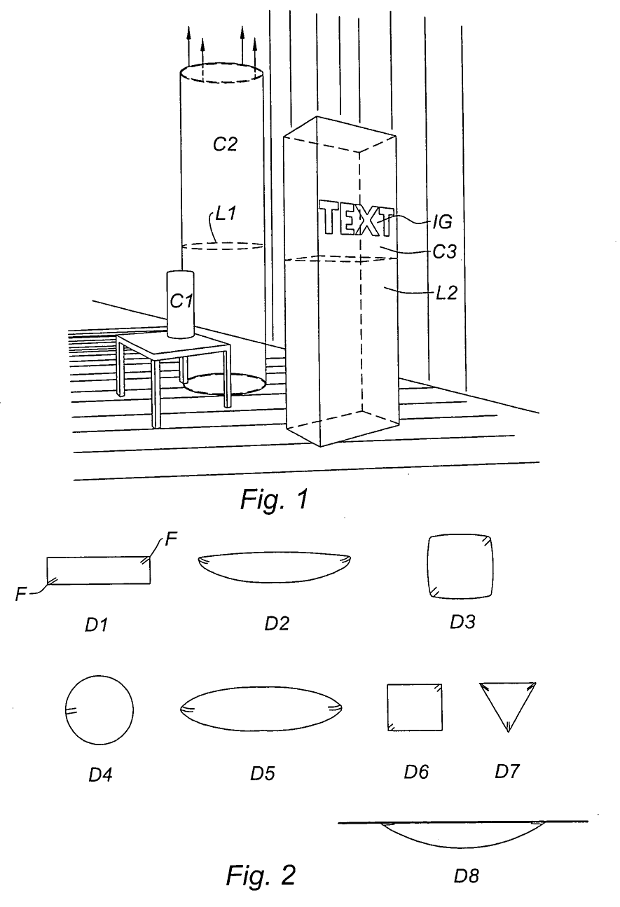

FIG. 1 illustrates three examples of display cases proposed by the invention. These cases are, in the case of C1, cylindrical in shape with a circular section and small dimension, in the case of C2, cylindrical in shape with a circular section and of relatively large dimensions made up of two parts or modules joined at a junction line L1. The third case C3 is a prismatic or cylindrical case with a rectangular section, also made up of two superposed modules joined at a junction line L2. IG highlights a detail on this case C3, schematically depicted by the word “text”.

Whether they are big or small, these cases comprise a carcass made up of one or more bent panels with cross-pieces on which one of more facing sheets displaying decorative elements, a text or information is held taut.

FIG. 2 provides a schematic illustration of different sections of cases such as those shown in FIG. 1. These cases of rectangular, semi-lentincular or square shapes with cambered sides, and circular, lenticular and square shapes with straight or triangular (D1-D7) or semi-lenticular sides D8 show the slots F on a level with the edges, which are used to secure the facing sheets. These sheets are provided with folded vertical edges which are slipped into the slots so that they can be retained there.

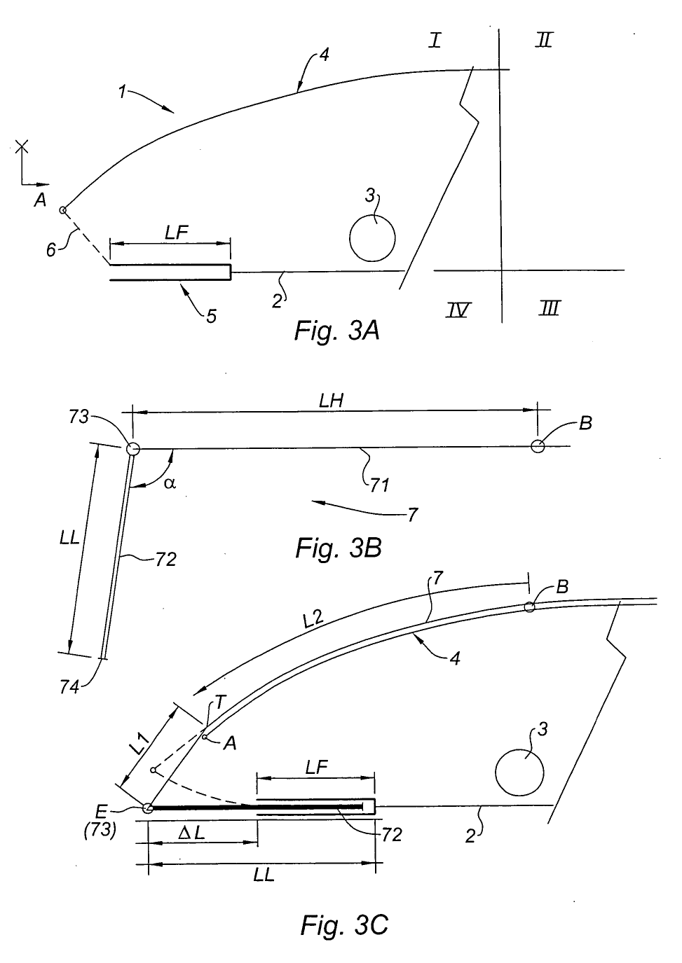

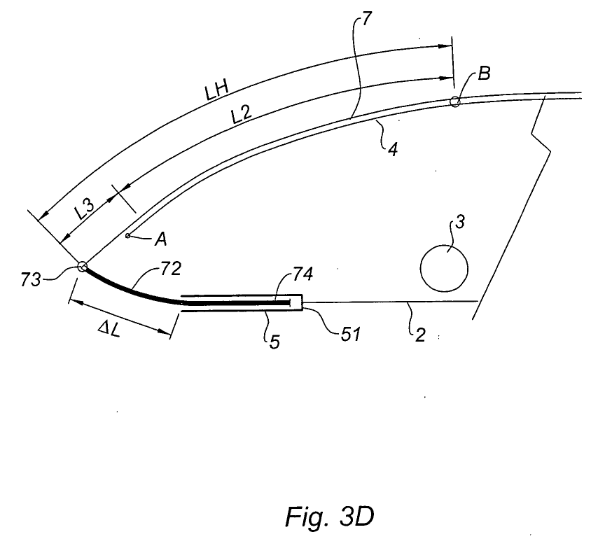

FIG. 3A illustrates a partial section of a display case without its facing sheet; only the elements of the case relevant to the description of the invention are illustrated. Only the part of the case contained in the portion denoted by I is illustrated; this section may be completed in the other portions II and/or III and/or IV by identical or similar shapes or even convex shapes of any type.

With or without facing, the case has a cylindrical or conical shape in the mathematical sense of these terms, i.e. a shape with a geometric surface created by a generatrix extending along a convex curve and remaining parallel in a given direction or passing through a fixed point.

In this example, the case 1 is a cylinder, the generatrix of which is perpendicular to the sheet of the drawing, and the directing curve on which the generatrix corresponding to the section of the cylinder extends is contained in the plane of the drawing.

The structure of the case 1 comprising a vertical carcass 2 fitted with equipment 3 such as lighting equipment, is joined to an external bent panel 4 represented by its section; the carcass has at least one narrow slot 5 extending along the height of the carcass and serving as a fitting slot, the width (depth) LF of which is defined.

In fact, this slot with a base is indicated by two walls disposed close together across the width LF. The slot may continue into a flared part, ensuring the continuity of shape and the junction with the bent panel. However, this flared part will not be considered as forming the fitting slot provided as a means of securing the folded edge of the facing sheet within the meaning of the invention.

The external bent panel 4 can be joined to the slot 5 in any manner, indicated by broken lines 6 in order to emphasise the lack of continuity of shape between the end A of the arc of the curve representing the section of the bent panel 4 and the opening of the fitting slot 5. The shape of the section of the bent panel 4 is convex with a continuous curvature or made up of segments combined to form a polygonal or combination contour.

Generally speaking, the carcass or bent panel and the facing sheets of the case are made from elastic, semi-rigid materials, permitting elastic deformations and in particular enable shocks to be absorbed without any deterioration in the initial shape. The semi-rigid materials of the bent panel of the case permit assembly by bending or conversely for dismantling and are transported flat. They are more rigid than the materials used for the facing sheets. In particular, the materials are translucent due to the fact that the case is illuminated from the interior. These materials are advantageously treated to render them fire-resistant.

FIG. 3B shows the section of the facing sheet 7, illustrated on the basis of the same conventions as the structure illustrated in FIG. 3A.

The sheet 7 comprises a body 71, at least the major part of which is designed to be applied against the bent panel 4, and a flexible strip 72 provided on at least one of its two longitudinal edges. The width of these edges is perpendicular to the sheet of the drawing.

The body 71 of the facing sheet is made up of a flexible material such as paper, non-woven material, thin plastic or a fabric and the strip 72 fixed to the facing sheet and constituting a fold line 73 on a level with the junction with the body of the sheet, the fitting strips not being illustrated. This may be achieved by adhering a marginal strip of the body of the sheet to the flexible strip. The articulation is schematically shown by the angle α, indicating that this angle is variable.

The facing sheet 7 is fixed to the structure 1 from one side by a fixing point B, not specifically illustrated here, and by the flexible strip 72, on the other hand, which is partially introduced into the fitting slot 5.

Between its fixing point B and its articulation edge 73, the body 71 of the facing sheet has a width LH and the flexible strip 72 has a width LL. The widths are measured, by definition, in the plane of FIGS. 3A-3C. The other dimension, perpendicular to this plane, is the “height” of the facing sheet or that of the structure of the geometric case or that of the strip.

The facing sheet 7 is fixed to the structure 1 at the point B in a linear arrangement. Likewise linear, the articulation corresponds to the edge 73 of the strip 72 referred to as the “fold side” edge, whilst its edge 74 is the outer edge.

The dimensions of the facing sheet 7 are defined on the basis of the structure on which it is used as a facing, as illustrated in FIG. 3C.

The strip 72 has a width LL greater than the depth LF of the fitting strip 5 or the part of the slot used for fitting, so that a free width ΔL(=LL−LF) is left free, which is capable of elastically deforming. In the non-operating position or non-deformed position when the sheet 71 is not fixed at B, for example, the strip 72 is flat or straight in alignment with the fitting strip, and its fold side edge 73 is disposed in the theoretical position E.

The width LH of the body 71 of the sheet 7 is defined on the basis of the non-deformed position of the flexible strip 72: the width LH is shorter than the length L1 between points E and B. The width LH of the body 71 of the sheet 7 on the basis of the non-deformed position of the flexible strip 72: the width LH is shorter than the length L1 between points E and B, i.e. the length of the cord extending between point B and point E. This cord has a contour conforming to the contour of the bent panel 4 and departs from it at the point of tangency T to conform to the straight contour as far as point E.

Based on the geometry of the section of the bent panel 4, the position of its edge A and the free width ΔL of the flexible strip 72, point T will be a point of contact (still denoted as the point of tangency) or a single point of flexion within the joint line or cord intersecting points E, T, B representing the maximum length of the geometric cord.

For the purpose of this definition, the width ΔL of the strip 72 is selected so that, when elastically deformed, the strip creates an appropriate constant tension which is exerted on the body 71 of the facing sheet 7 and applies it fully or partially against the bent panel 4.

In this theoretical illustration, the strip 72 is considered to be in a neutral position in order to define the width of the different elements constituting the facing sheet, as explained above. However, such a situation does not exist in practice because the strip must always tauten the facing sheet 7 on the bent panel 4. In reality, the strip is deformed at its free part ΔL and its folded side edge 73 is pulled towards point B.

FIG. 3D illustrates a facing sheet, the width LH of width is defined as described above so that it is tensed transversely (relative to the height direction perpendicular to the sheet of the drawing) between its fixing joint B and its edge 73 joined to the strip 72. This drawing highlights the flexing of the elastic strip 72 along its free width ΔL.

The link between the edge A of the bent panel 4 and the opening of the fitting slot 5 are not illustrated in FIGS. 3A-3D, the primary purpose being to illustrate the fact that the fitting system affords a locking action and permits the deformation of the free width ΔL of the strip 72.

It should also be emphasised that the locking effect of the fraction of width DL of the flexible strip 72 assumes that its outer edge 74 sits in abutment with the base 51 of the fitting slot 5.

The invention as described with reference to FIGS. 3A-3D applies under the same conditions at the other edge of the structure 1, on a level with another slot receiving the flexible strip of the other edge of the facing sheet.

This arrangement of the second edge of the facing sheet therefore replaces the fixing point B used in the schematic illustration above with a view to simplifying the description of the invention. In this embodiment of the case and its facing sheet, the width of the body of the sheet is defined on the basis of the ends E of the two strips in the theoretical non-operating position, aligned with the fitting slots.

Although, for reasons of equilibrium and with a view to distributing the tension and to simplify manufacture of the case and in particular its facing sheet, it is preferable if the sheet is symmetrical, identical to the flexible strips, it is also possible, if necessary for other reasons, to opt for a situation in which only one of the strips has a free width ΔL, which thus applies the tension to the body of the facing sheet.

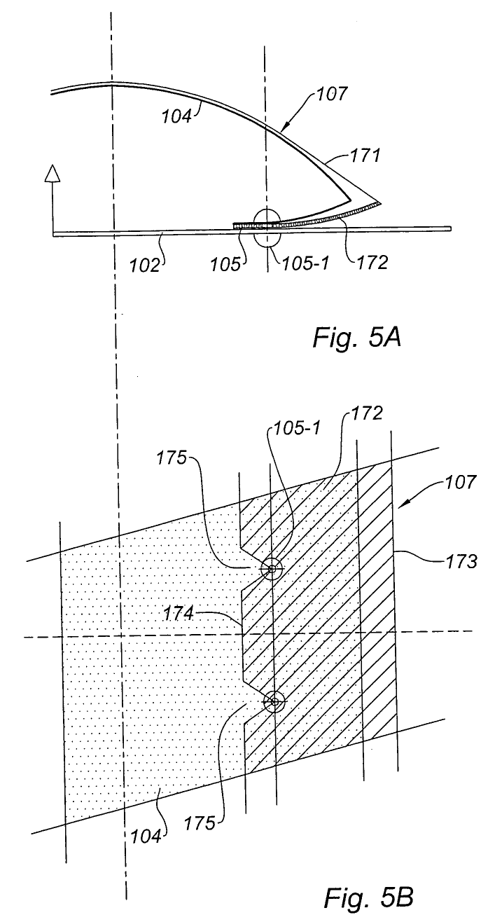

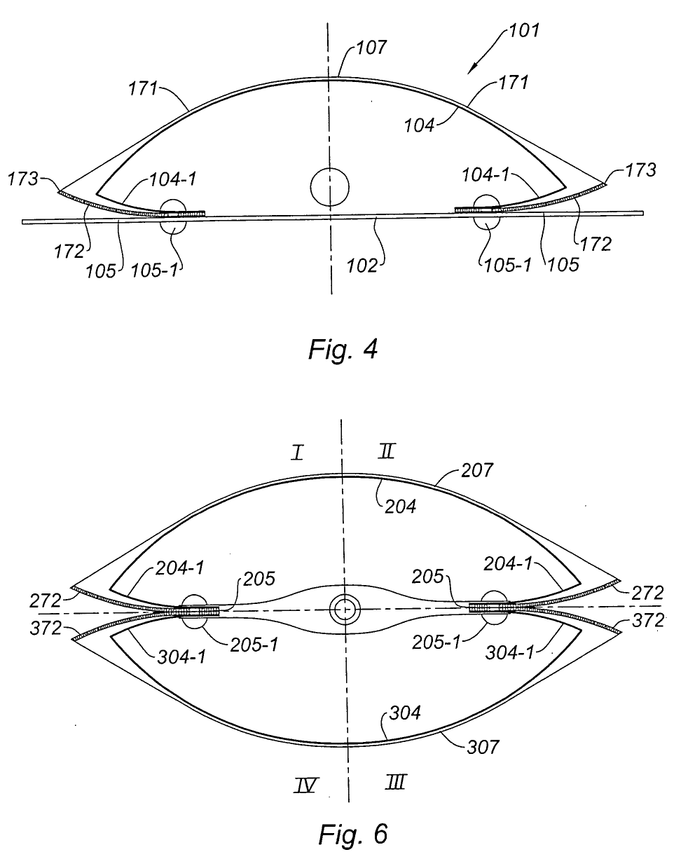

FIG. 4 is a section similar to that of the previous drawings illustrating an embodiment of a display case 101, the structure of which has a vertical carcass 102 in the form of a panel with a rigid plane, to which a bent panel 104 with folded-back flaps 104-1 forming fitting slots 105 in conjunction with the carcass 102 is secured; the folded-back flaps 104-1 are joined to the panel 102 by removable joining means such as rivets 105-1 or press studs such as double collar rivets to permit a positioning clearance for the strip 72. A double collar rivet is a rivet which leaves a fixed clearance free between the two parts which it clamps, in the manner of a bolt provided with a washer between the clamped parts.

The fitting slots 105 continue, following a flared opening due to the particular shape of the folded-back flaps 104-1. The facing sheet 107 is made up of a body 171 bordered at the two sides by two flexible strips 172, each joined to the body 171 by an articulation line 173. The part of the flexible strips 172 which is not secured in the slot is elastically deformed and tenses the body 171 of the sheet against a part of the bent panel 104. The symmetrical shape of this assembly merely corresponds to a specific choice and is not indispensable.

The dimensions of the flexible strips 172 have been exaggerated in order to highlight the characteristics of the invention.

FIGS. 5A, 5B illustrate an embodiment of the fitting of the flexible strip of a facing sheet in the fitting slot corresponding to one of those illustrated in the embodiment of FIG. 4.

The fitting slot 105 is in fact formed by the folded back flap 104-1 around a double collar rivet 105-1 and the outer edge 174 of the strip 172 indicated by hatching has notches 175 in the positions corresponding to those of the rivets 105-1 which sit round these rivets and are fixed between the folded-back flaps 104-1 and the carcass 102.

FIG. 6 illustrates an embodiment which is doubly symmetrical in the sections I, II, III, IV.

The carcass is made up of two bent panels with a lenticular section 204, 304, the two folded-back flaps 204-1 and 304-1 of which are assembled in pairs by means of rivets 205-1 as in the embodiment illustrated in FIG. 4, thereby forming fitting slots 205 common to the two bent panels.

Each of the two bent panels 204, 304 receives a facing sheet 207, 307 incorporating two flexible strips 272, 372 which, when fitted, flex to produce the tension in the bodies 271, 371 of the facing sheets 207, 307.

It should be pointed out that the display case may be made up of several modules superposed across the required height. The display case may either be disposed standing upright or suspended. The modules are advantageously assembled with the aid of the flexible strips, with the facing sheets overlapping two case modules, because the assembly sheet may have a height corresponding to the total height of the superposed modules constituting the case as a whole, since the facing sheet merely has to be unrolled with its flexible edges deployed, i.e. sitting flat.

1) Display case with a geometric surface having a geometric structure with a convexly shaped section formed by a carcass supporting a bent panel provided with one or more longitudinal slots, and at least one facing sheet placed on the exterior against the bent carcass sheet in order to envelop it, of which at least one lateral, folded edge is inserted through a longitudinal slot of the structure in order to retain the sheet, wherein
the slot of the carcass constitutes a fitting slot,
at least one of the lateral edges of the sheet is provided with a flexible strip forming a fold line at its junction with the body of the sheet and designed to be engaged in the fitting slot by a part of its width on the side of its free edge, whilst the remaining part of the width of the fold side strip is able to deform elastically and freely relative to the fitting slot and the structure,
the width of the body of the sheet, as measured between the fold side edge of the strip and its other edge fixed to the structure is shorter than the length of the cord at least partially supported on the structure and measured between the fixed edge of the sheet and the edge of the strip on the fold side when the strip is in a neutral position in which it is not elastically deformed so that the strip engaged in a fixing slot tautens the sheet transversely against the bent panel of the carcass due to the tension generated by the elastic deformation of the flexible strip.

2) Display case as claimed in claim 1, wherein
the other lateral edge of the sheet is also provided with a flexible strip designed to be engaged in another fitting slot where it is retained on a part of its width on the side of the free edge, whereas the remaining part of the width of the fold side strip is able to deform elastically relative to the slot and the structure, and
the body of the sheet has a width as measured between its two folds and shorter than the length of the cord at least partially supported on the structure and measured between the edge of each fold side strip when at least one of the strips is in a neutral position that is not elastically deformed.

3) Display case as claimed in claim 1, wherein at least one of the flexible strips of the sheet has a width that is bigger than the depth of the slot.

4) Display case as claimed in claim 1, wherein the case is formed by assembling a bent panel with folded-back edges and a carcass to which the folded-back edges are secured in order to form the fitting slots.

5) Display case as claimed in claim 1, wherein the case is formed by assembling two or more bent panels with folded-back edges, joined by these folded-back edges to form fitting slots for the flexible strips of the facing sheets.

6) Display case as claimed in claim 4, wherein the joint between a folded-back flap and a carcass forming the fitting slots are assembled by intermittent assembly points in the form of rivets or press studs distributed in a defined manner across the height of each slot to form fitting zones around each rivet and
the flexible strips of the facing sheets have outer edges provided with notches distributed with the same spacing as the rivets, which sit round the rivets and are fixed in the slots.

7) Display case as claimed in claim 1, which is formed by superposing modules joined by the flexible strips of at least one facing sheet extending across the height of several case modules.

8) Display case as claimed in claim 1, wherein the bent panels are assembled by rivets or bolts and other joining means, which engage in the slots of the folds of the bent panels in a mutually facing arrangement.

9) Display case as claimed in claim 1, wherein the axis of the case has an axis that is different from the vertical.

10) Display case as claimed in claim 9, which is made up of several elements in a non-vertical position and wherein the cohesion of the case is maintained by additional rigid elements.

11) Display case as claimed in claim 10, wherein the additional rigid elements comprise an internal, translucent plastic tube joined to cross-pieces and the bent panels of the structure.

12) Display case as claimed in claim 5, wherein the joined folds of the bent panels forming the fitting slots are assembled by intermittent assembly points in the form of rivets or press studs distributed in a defined manner across the height of each slot to form fitting zones around each rivet, and the flexible strips of the facing sheets have outer edges provided with notches distributed with the same spacing as the rivets, which sit round the rivets and are fixed in the slots.

13) Display mount comprising:
a panel provided with a longitudinal slot, the bent panel forming a developable convexly shaped section; and
a facing sheet arranged to be placed on the exterior over the panel, the facing sheet having a body and one of the lateral edges of the facing sheet having a flexible strip forming a fold line at its junction with the body of the facing sheet and having a free edge at the side of the flexible strip away from the fold line; wherein
the flexible strip of the facing sheet is arranged to be inserted into the longitudinal slot to attach and retain the facing sheet, and the slot receives part of the width of the flexible strip along the free edge and restrains that part against lateral movement, while the remaining part of the width of the flexible strip is free to deform elastically laterally relative to the slot;
the body of the flexible sheet is arranged to be attached at a point of attachment remote from the flexible strip across the panel;
the width of the body of the facing sheet, as measured between the fold line and the point of attachment, is shorter than the length of an imaginary taut thread at least partially supported on the bent panel and extending from the point of attachment to the position that the fold line occupies when the flexible strip is inserted in the slot but is in a neutral position in which it is not elastically deformed, so that when the facing sheet is attached at the point of attachment and the flexible strip is engaged in the slot, the flexible strip is elastically deformed laterally and the tension generated by the elastic restoring force of the flexible strip tautens the facings sheet transversely against the bent panel of the shell.

14) Display mount as claimed in claim 13, wherein the point of attachment is formed by a second flexible strip joined at a fold line along the other lateral edge of the body of the flexible sheet and a second slot in the display mount into which the second flexible strip is arranged to fit.

15) Display mount as claimed in claim 14, wherein the second flexible strip is designed to be engaged in the second slot over part of the width of the second flexible strip along a free edge, the remaining part of the width of the second flexible strip being free to deform laterally elastically relative to the second slot, and
the body of the flexible sheet has a width between its two fold lines that is shorter than the length of an imaginary thread at least partially supported on the bent panel and extending between the positions that each fold line occupies when the respective flexible strip is engaged in the respective slot but is in a neutral position that is not elastically deformed.

16) Display mount as claimed in claim 13, wherein:
the panel has folded-back edges;
the folded-back edges are secured to a shell of the display mount; and the slot is formed by a space between the shell and the folded-back edge of the panel.

17) Display mount as claimed in claim 13, further comprising two or more said panels with folded-back edges, joined by these folded-back edges, and wherein the slot for the flexible strip of the facing sheet is formed between the folded-back edges of the facing sheets.

18) Display mount as claimed in claim 13, wherein the slot is formed between components assembled by intermittent assembly points distributed in a defined manner along the height of the slot, and the flexible strip of the facing sheet has an outer edge provided with notches distributed in the same defined manner, which notches seat round the assembly points.

19) Display mount as claimed in claim 13, which comprises superposed modules, wherein the facing sheet extends over more than one module, and wherein modules are joined by the flexible strip of the facing sheet extending over more than one module.
